(19) United States
(12) Patent Application Publication
(10) Pub. No.: US 2024/0064533 A1
(43) Pub. Date: Feb. 22, 2024

(54) WIRELESS COMMUNICATION MANAGEMENT APPARATUS, WIRELESS COMMUNICATION MANAGEMENT METHOD, AND WIRELESS COMMUNICATION MANAGEMENT PROGRAM

(71) Applicant: Nippon Telegraph and Telephone Corporation, Tokyo (JP)

(72) Inventors: Shoko SHINOHARA, Musashino-shi, Tokyo (JP); Yasuhiko INOUE, Musashino-shi, Tokyo (JP); Yusuke Asai, Musashino-shi, Tokyo (JP); Yasushi TAKATORI, Musashino-shi, Tokyo (JP)

(21) Appl. No.: 18/267,545

(22) PCT Filed: Dec. 25, 2020
(86) PCT No.: PCT/JP2020/048618

§ 371 Date: Jun. 15, 2023

(51) Int. Cl. H04W 24/02; H04W 72/20

(52) U.S. Cl. CPC H04W 24/02; H04W 72/20; H04W 84/12

(57) ABSTRACT

A wireless communication management apparatus (100) includes: a reception unit (112) that receives first wireless environment information from a terminal (300) configured to wirelessly communicate with a base station (200); a generation unit (113) that generates first control information of the terminal on the basis of first wireless environment information; and a transmission unit (115) that transmits the first control information to update a setting of the terminal.

### TECHNICAL FIELD

An embodiment relates to a wireless communication management apparatus, a wireless communication management method, and a wireless communication management program.

### BACKGROUND ART

A wireless communication system including a base station and a terminal is known.

A typical example of a wireless communication system is a wireless local area network (LAN) for public use. As a wireless LAN for public use, for example, a use case in which data is transmitted from a base station to a public computer terminal and a smartphone terminal is assumed.

On the other hand, in recent years, a wireless LAN for industrial use has appeared. As a wireless LAN for industrial use, for example, a use case in which data measured by an internet of things (IoT) terminal is transmitted to a base station is assumed.

### CITATION LIST

### Non Patent Literature

Non Patent Literature 1: ARIB STD-T108 1.3, “920 MHz-Band Telemeter, Telecontrol and Data Transmission Radio Equipment and Standards”, Apr. 12, 2019
Non Patent Literature 2: IEEE Std 802.11ah TM-2016 (IEEE Standard for Information technology—Telecommunications and information exchange between systems Local and metropolitan area networks—Specific requirements, Part 11:Wireless LAN Medium Access Control (MAC) and Physical Layer (PHY) Specifications, Amendment 2:Sub 1 GHz License Exempt Operation, IEEE Computer Society, 7 Dec. 2016

### SUMMARY OF INVENTION

### Technical Problem

In a use case of a wireless LAN for public use, data transmission (downlink traffic) from a base station to an unspecified number of terminals is assumed to be the main communication. Therefore, in a case of managing a wireless LAN for public use, various types of control information are generated on the basis of the wireless environment of the base station. In other words, when managing a wireless LAN for public use, the wireless environment of a terminal is not considered.

On the other hand, in a use case of a wireless LAN for industrial use, data transmission (uplink traffic) from a specific large number of terminals to a base station is assumed to be the main communication. Therefore, in a case where the management method of the wireless environment of a wireless LAN for public use is applied to a wireless LAN for industrial use, it may be difficult to curb degradation of throughput. Specifically, with the management method of the wireless environment of a wireless LAN for public use, there is a possibility that the wireless environment of uplink traffic assumed as the main communication in the wireless LAN for industrial use is not improved.

The present invention has been made in view of the above circumstances, and an object thereof is to provide means for appropriately managing wireless communication in a wireless communication system in which uplink traffic is assumed to be the main communication.

### Solution to Problem

A wireless communication management apparatus of one aspect includes: a reception unit that receives first wireless environment information from a terminal configured to wirelessly communicate with a base station; a generation unit that generates first control information of the terminal on the basis of the first wireless environment information; and a transmission unit that transmits the first control information to update a setting of the terminal.

### Advantageous Effects of Invention

According to the embodiment, it is possible to provide a method of appropriately managing wireless communication in a wireless communication system in which uplink traffic is assumed to be the main communication.

### BRIEF DESCRIPTION OF DRAWINGS

FIG. 1 is a block diagram illustrating an example of a configuration of a communication system according to an embodiment.

FIG. 2 is a block diagram illustrating an example of a hardware configuration of a wireless communication management apparatus according to the embodiment.

FIG. 3 is a block diagram illustrating an example of a hardware configuration of a base station according to the embodiment.

FIG. 4 is a block diagram illustrating an example of a hardware configuration of a terminal according to the embodiment.

FIG. 5 is a block diagram illustrating an example of a functional configuration of the wireless communication management apparatus according to the embodiment.

FIG. 6 is a block diagram illustrating an example of a functional configuration of the base station according to the embodiment.

FIG. 7 is a block diagram illustrating an example of a functional configuration of the terminal according to the embodiment.

FIG. 8 is a state transition diagram related to a wireless communication management operation in the wireless communication management apparatus according to the embodiment.

FIG. 9 is a flowchart illustrating an example of the wireless communication management operation in the wireless communication management apparatus according to the embodiment.

FIG. 10 is a flowchart illustrating an example of a collection operation in the wireless communication management apparatus according to the embodiment.

FIG. 11 is a flowchart illustrating an example of an update operation in the wireless communication management apparatus according to the embodiment.

FIG. 12 is a block diagram illustrating an example of a configuration of a communication system according to a modification of the embodiment.

FIG. 13 is a block diagram illustrating an example of a functional configuration of a relay base station according to the modification of the embodiment.

### DESCRIPTION OF EMBODIMENTS

Hereinafter, an embodiment will be described with reference to the drawings. Note that in the following description, components having the same function and configuration are denoted by the same reference numerals. In addition, when distinguishing among a plurality of components having a common reference sign, the component is distinguished by an additional reference sign (e.g., hyphen and number such as “−1”) attached after the common reference sign.

1. Embodiment

1.1 Configuration

A configuration of a communication system according to an embodiment will be described.

1.1.1 Overall Configuration

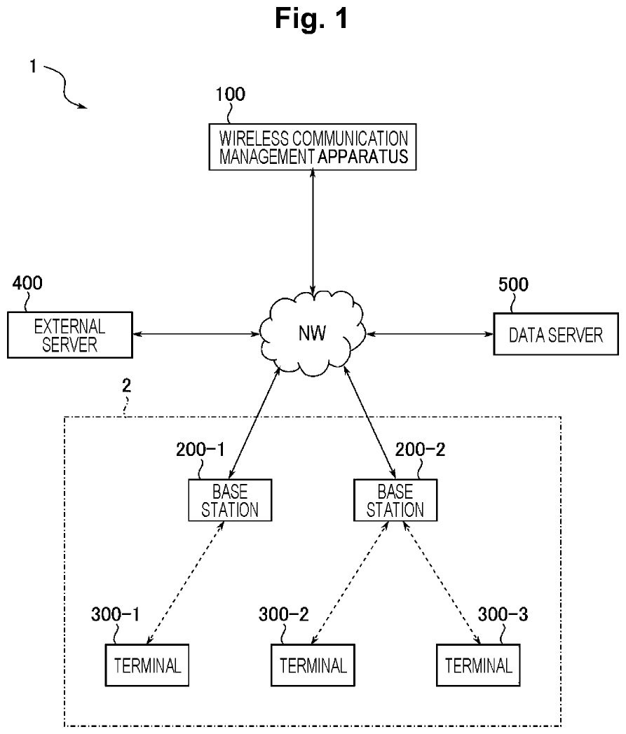

First, a configuration of the communication system according to the embodiment will be described. FIG. 1 is a block diagram illustrating an example of the configuration of the communication system according to the embodiment.

As illustrated in FIG. 1, a communication system 1 is a system that manages a wireless environment of a wireless communication system 2. The communication system 1 includes a wireless communication management apparatus 100, a plurality of base stations 200-1 and 200-2, a plurality of terminals 300-1, 300-2, and 300-3, an external server 400, and a data server 500. The plurality of base stations 200-1 and 200-2 and the plurality of terminals 300-1 to 300-3 form the wireless communication system 2.

Hereinafter, each of the plurality of base stations 200-1 and 200-2 may be referred to as “base station 200” unless otherwise distinguished. Each of the plurality of terminals 300-1 to 300-3 may be referred to as “terminal 300” unless otherwise distinguished. Furthermore, the base station 200 and the terminal 300 may be collectively referred to as “device”.

The wireless communication system 2 is a wireless communication system for industrial use. The wireless communication system 2 is configured to use a frequency band (unlicensed band) that can be used without a wireless station license. In the wireless communication system 2, for example, a sub-GHz band is used as an unlicensed band. The sub-GHz band includes, for example, the 920 MHz band.

The wireless communication management apparatus 100 is an on-premises data processing server for managing a wireless environment of the wireless communication system 2. The wireless communication management apparatus 100 is configured to establish wired connection with the base station 200, the external server 400, and the data server 500 via, for example, a router or a hub (not illustrated) in a network NW.

The base station 200 is a master unit (AP: access point) of the wireless communication system 2. The base station 200 is configured to connect the terminal 300 and the wireless communication management apparatus 100 and connect the terminal 300 and the data server 500 via the network NW.

The terminal 300 is a slave unit (STA: station) of the wireless communication system 2. The terminal 300 is, for example, an IoT terminal. The terminal 300 is configured to wirelessly connect to a corresponding base station 200.

In the example of FIG. 1, the terminal 300-1 is configured to wirelessly connect to the base station 200-1. The terminals 300-2 and 300-3 are configured to wirelessly connect to the base station 200-2. However, the terminal 300-1 may also be configured to wirelessly connect to the base station 200-2. The terminals 300-2 and 300-3 may also be configured to wirelessly connect to the base station 200-1. In this manner, the wireless connection between the terminal 300 and the base station 200 may be appropriately selected from a plurality of paths.

The external server 400 is a server that stores information (external environment information) regarding the external environment of the wireless communication system 2.

The data server 500 is a server in which sensor information measured by the wireless communication system 2 is aggregated and stored.

1.1.2 Hardware Configuration

Next, a hardware configuration of a main configuration in the communication system according to the embodiment will be described.

(Wireless Communication Management Apparatus)

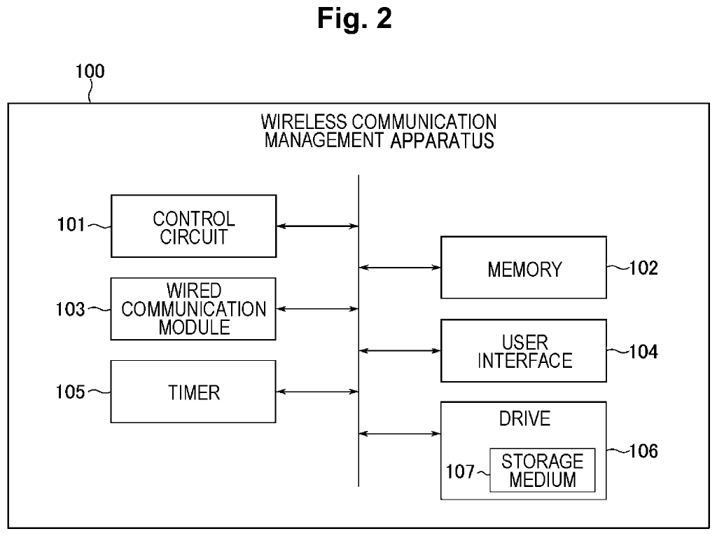

FIG. 2 is a block diagram illustrating an example of a hardware configuration of the wireless communication management apparatus according to the embodiment.

The wireless communication management apparatus 100 includes a control circuit 101, a memory 102, a wired communication module 103, a user interface 104, a timer 105, and a drive 106.

The control circuit 101 is a circuit that has overall control of the components of the wireless communication management apparatus 100. The control circuit 101 includes a central processing unit (CPU), a random access memory (RAM), a read only memory (ROM), and the like.

The memory 102 is an auxiliary storage device of the wireless communication management apparatus 100. The memory 102 includes, for example, a hard disk drive (HDD), a solid state drive (SSD), a memory card, and the like. The memory 102 stores various types of information used for a wireless communication management operation and a wireless communication management program. The wireless communication management program can be stored in the memory 102 by being transmitted from outside the wireless communication management apparatus 100 via the network NW.

The wireless communication management operation is a series of operations performed to appropriately manage a wireless communication environment in the wireless communication system 2. The wireless communication management program is a program for causing the control circuit 101 to perform the wireless communication management operation. Details regarding the wireless communication management operation will be described later.

The wired communication module 103 is a circuit used for transmission and reception of data by a wired signal. The wired communication module 103 is configured, for example, to conform to the TCP/IP hierarchical model. Specifically, for example, a configuration of the wired communication module 103 corresponding to the network interface layer is compliant with Ethernet. A configuration of the wired communication module 103 corresponding to the internet layer is compliant with the internet protocol (IP). A configuration of the wired communication module 103 corresponding to the transport layer is compliant with the transmission control protocol (TCP). A configuration of the wired communication module 103 corresponding to the application layer is compliant with the Secure shell (SSH).

The user interface 104 is a circuit for communicating information between the user and the control circuit 101. The user interface 104 includes an input device and a display device. The input device includes, for example, a touch panel, an operation button, and the like. The display device includes, for example, a liquid crystal display (LCD), an electroluminescence (EL) display, and the like. The user interface 104 converts an input (user input) from the user into an electrical signal, and then transmits the electrical signal to the control circuit 101.

The timer 105 is a circuit that measures time. For example, the timer 105 starts counting on the basis of a start instruction from the control circuit 101 (set). When the count value becomes equal to or larger than a threshold in the set state, the timer 105 notifies the control circuit 101 of a timeout (timeout). The timer 105 ends counting on the basis of an end instruction from the control circuit 101 (reset).

The drive 106 is a device for reading a program stored in a storage medium 107. The drive 106 includes, for example, a compact disk (CD) drive, a digital versatile disk (DVD) drive, and the like.

The storage medium 107 is a medium that accumulates information such as programs by electrical, magnetic, optical, mechanical, or chemical action. The storage medium 107 may store the wireless communication management program.

(Base Station)

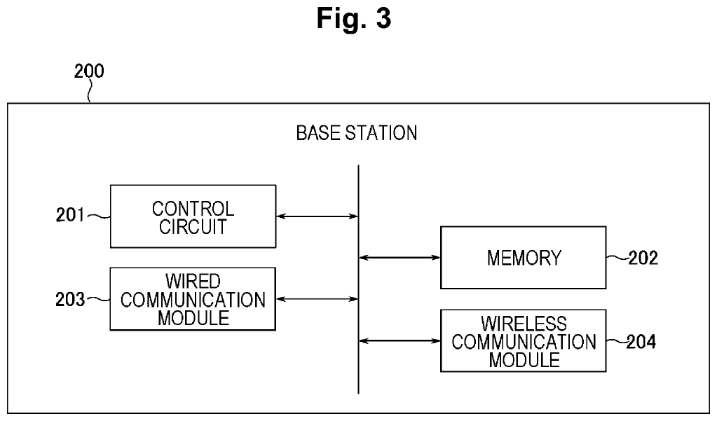

FIG. 3 is a block diagram illustrating an example of a hardware configuration of the base station according to the embodiment.

As illustrated in FIG. 3, the base station 200 includes a control circuit 201, a memory 202, a wired communication module 203, and a wireless communication module 204.

The control circuit 201 is a circuit that has overall control of the component of the base station 200. The control circuit 201 includes a CPU, a RAM, a ROM, and the like.

The memory 202 is an auxiliary storage device of the base station 200. The memory 202 includes, for example, an HDD, an SSD, a memory card, and the like. The memory 202 stores control information of the base station 200 generated by the wireless communication management apparatus 100 in the wireless communication management operation.

The wired communication module 203 is a circuit used for transmission and reception of data by a wired signal. The wired communication module 203 conforms to a protocol stack equivalent to that of the wired communication module 103. With this configuration, the wired communication module 203 can be connected to the wired communication module 103 by wire.

The wireless communication module 204 is a circuit used for transmission and reception of data by a wireless signal. The wireless communication module 204 is connected to an antenna (not illustrated). The wireless communication module 204 is configured, for example, to conform to the TCP/IP hierarchical model. Specifically, for example, a configuration of the wireless communication module 204 corresponding to the network interface layer is compliant with institute of electrical and electronics engineers (IEEE) 802.11 ah. A configuration of the wireless communication module 204 corresponding to the Internet layer is compliant with the IP. A configuration of the wireless communication module 204 corresponding to the transport layer is compliant with the TCP. A configuration of the wireless communication module 204 corresponding to the application layer is compliant with the SSH.

(Terminal)

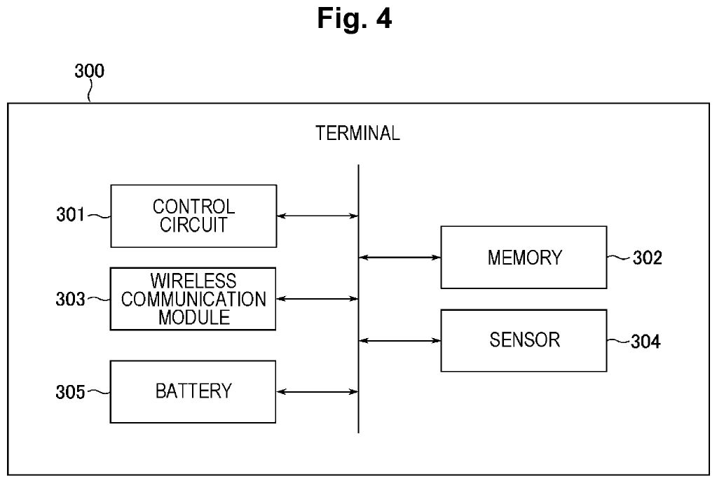

FIG. 4 is a block diagram illustrating an example of a hardware configuration of the terminal according to the embodiment.

As illustrated in FIG. 4, the terminal 300 includes a control circuit 301, a memory 302, a wireless communication module 303, a sensor 304, and a battery 305.

The control circuit 301 is a circuit that has overall control of the components of the terminal 300. The control circuit 301 includes a CPU, a RAM, a ROM, and the like.

The memory 302 is an auxiliary storage device of the terminal 300. The memory 302 includes, for example, an HDD, an SSD, a memory card, and the like. The memory 302 stores control information generated by the wireless communication management apparatus 100 in the wireless communication management operation and sensor information measured by the sensor 304.

The wireless communication module 303 is a circuit used for transmission and reception of data by a wireless signal. The wireless communication module 303 conforms to a protocol stack equivalent to that of the wireless communication module 204. With this configuration, the wireless communication module 303 can be wirelessly connected to the wireless communication module 204.

The sensor 304 is a circuit that measures data monitored by the wireless communication system 2. Sensor information measured by the sensor 304 is aggregated in the data server 500 via the base station 200 and the network NW.

The battery 305 is a capacity for supplying power to the terminal 300. The battery 305 is charged by, for example, a solar power generation module (not illustrated). Note that while FIG. 4 describes a case where the terminal 300 supplies power by charging the battery 305 by solar power generation, the present invention is not limited thereto. For example, the terminal 300 may be stably supplied with power from a power supply.

1.1.3 Functional Configuration

Next, a functional configuration of a main configuration in the communication system of the embodiment will be described.

(Wireless Communication Management Apparatus)

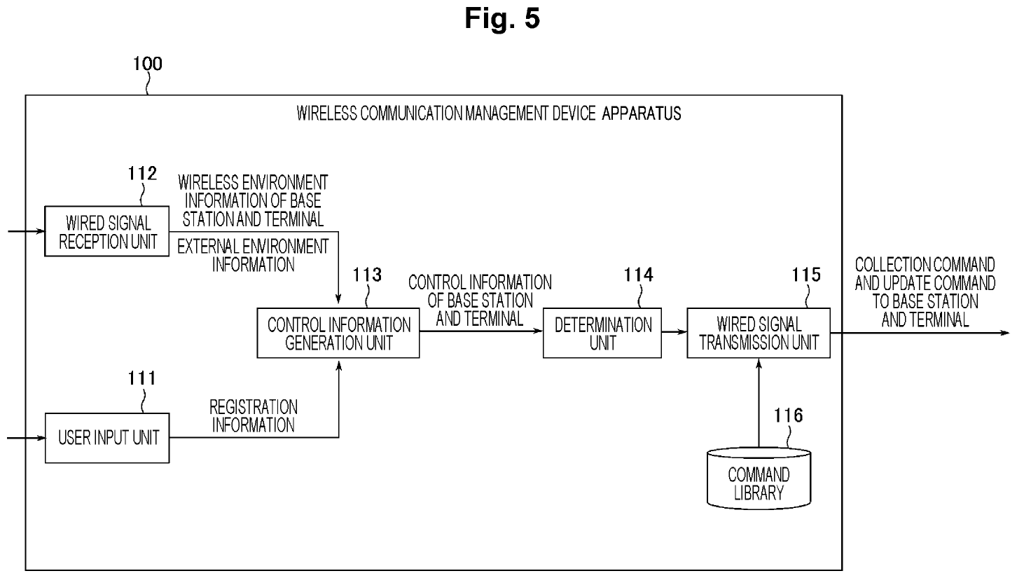

FIG. 5 is a block diagram illustrating an example of a functional configuration of the wireless communication management apparatus according to the embodiment.

The CPU of the control circuit 101 loads the wireless communication management program stored in the memory 102 or the storage medium 107 into the RAM. Then, the CPU of the control circuit 101 controls each of the components 102 to 106 by interpreting and executing the wireless communication management program expanded in the RAM. As a result, as illustrated in FIG. 5, the wireless communication management apparatus 100 functions as a computer including a user input unit 111, a wired signal reception unit 112, a control information generation unit 113, a determination unit 114, a wired signal transmission unit 115, and a command library 116.

The user input unit 111 transmits registration information input by the user to the control information generation unit 113. Registration information includes device information and constraint information.

Device information is information for the wireless communication management apparatus 100 to uniquely identify the base station 200 and the terminal 300. Device information includes, for example, a username, a password, an IP address, a management target flag, and the like for each of the base station 200 and the terminal 300. The username, the password, and the IP address are used for the wireless communication management apparatus 100 to log in to the base station 200 and the terminal 300 by SSH. The management target flag is information for identifying whether or not the corresponding base station 200 and terminal 300 are targets of the wireless communication management operation.

Constraint information is information indicating constraint conditions to be complied with by the wireless communication system 2 on the basis of laws such as the Radio law. Constraint information includes, for example, an upper limit value of the total transmission time for each device.

The wired signal reception unit 112 receives wireless environment information of the base station 200 and the terminal 300 from the base station 200. The wired signal reception unit 112 receives external environment information from the external server 400. The wired signal reception unit 112 transmits the received pieces of environment information to the control information generation unit 113.

Wireless environment information is information collected from the base station 200 and the terminal 300 to evaluate the throughput of wireless communication in the wireless communication management operation. Wireless environment information includes, for example, an SSID, a channel, a bandwidth, a frequency, a received signal strength indication (RSSI), and the like of a peripheral basic service set (BSS) as information common to the base station 200 and the terminal 300. Furthermore, wireless environment information can include, for example, information indicating the remaining capacity of the battery 305 as information specific to the terminal 300.

External environment information is information collected from the external server 400 to evaluate the throughput of wireless communication. External environment information includes, for example, a predicted value of sunshine hours in an area where the wireless communication system 2 is provided.

The control information generation unit 113 generates control information of the base station 200 and the terminal 300 on the basis of registration information, wireless environment information of the base station 200 and the terminal 300, and external environment information. The control information generation unit 113 may store the received pieces of information in the memory 102 until all the information used for the wireless communication management operation is prepared. The control information generation unit 113 transmits the generated control information to the determination unit 114.

Control information is a parameter used for constructing a wireless communication environment of the base station 200 and the terminal 300. The control information of a certain device is generated on the basis of at least the wireless environment information collected from the certain device. The control information of a certain device may be generated further on the basis of wireless environment information collected from devices other than the certain device. Control information includes access parameters, channels, and transmission rates of the base station 200 and the terminal 300. In addition, control information includes information indicating transmission time zones and a transmission frequency (duty ratio) of the base station 200 and the terminal 300.

The determination unit 114 determines whether or not to update the setting of the wireless environment by the generated control information for each of the base station 200 and the terminal 300 for which the control information has been generated. In addition, the determination unit 114 further determines, for each of the base station 200 and the terminal 300 determined to update the setting of the wireless environment, whether or not the update involves a restart. The determination unit 114 transmits a set of control information and a determination result for each of the base station 200 and the terminal 300 to the wired signal transmission unit 115.

The wired signal transmission unit 115 generates various commands for controlling the base station 200 and the terminal 300 on the basis of an instruction from the control circuit 101. The various commands are generated with reference to the command library 116.

In the command library 116, a command group used for the wireless communication management operation is stored in advance. The command library 116 stores, for example, a collection command and an update command. The collection command is a command for collecting wireless environment information from the designated base station 200 or terminal 300 (designated by IP address or the like). The update command is a command for updating the setting of the wireless environment of the designated base station 200 or terminal 300 (designated by IP address or the like) with the control information. Therefore, the update command includes control information for updating the setting of the wireless environment of the designated base station 200 or terminal 300. In addition, the update command may include an instruction to restart the designated base station 200 or terminal 300.

(Base Station)

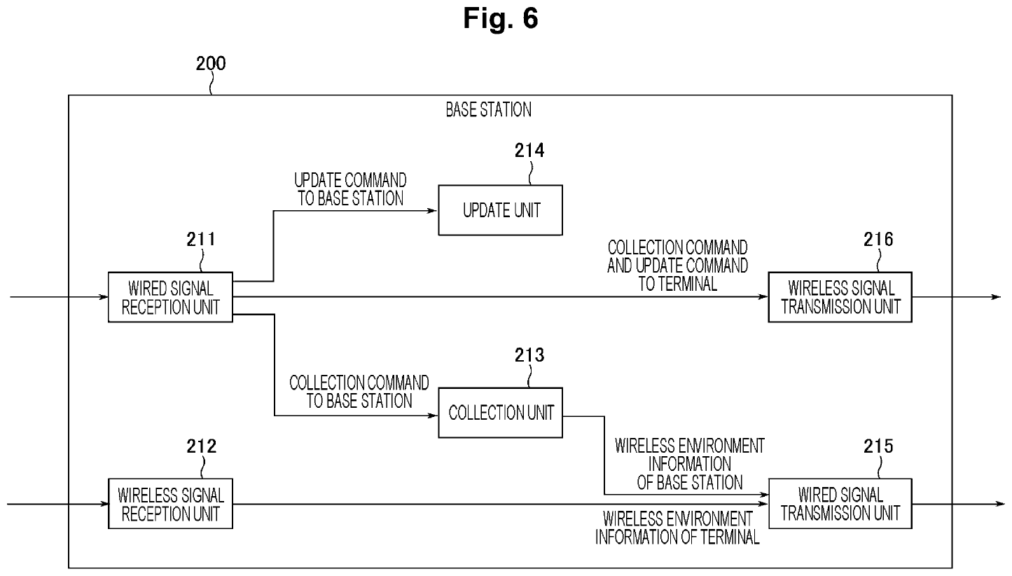

FIG. 6 is a block diagram illustrating an example of a functional configuration of the base station according to the embodiment.

The CPU of the control circuit 201 controls each of the components 202 to 204 on the basis of various commands transmitted from the wireless communication management apparatus 100. As a result, as illustrated in FIG. 6, the base station 200 functions as a computer including a wired signal reception unit 211, a wireless signal reception unit 212, a collection unit 213, an update unit 214, a wired signal transmission unit 215, and a wireless signal transmission unit 216.

The wired signal reception unit 211 receives a collection command and an update command from the wireless communication management apparatus 100. When receiving a collection command (to base station 200) addressed to the base station 200, the wired signal reception unit 211 transmits the collection command to the collection unit 213. When receiving an update command to the base station 200, the wired signal reception unit 211 transmits the update command to the update unit 214. When receiving a collection command and an update command (to terminal 300) addressed to the terminal 300, the wired signal reception unit 211 transmits the collection command and the update command to the wireless signal transmission unit 216. When data is transmitted from the wired signal reception unit 211 to the wireless signal transmission unit 216, the transmission data is converted from the Ethernet frame format to the 802.11 ah frame format.

The wireless signal reception unit 212 receives wireless environment information of the terminal 300 from the terminal 300. The wireless signal reception unit 212 transmits the received wireless environment information of the terminal 300 to the wired signal transmission unit 215. When data is transmitted from the wireless signal reception unit 212 to the wired signal transmission unit 215, the transmission data is converted from the 802.11 ah frame format to the Ethernet frame format.

The collection unit 213 collects wireless environment information of the base station 200 on the basis of the received collection command. The collection unit 213 transmits the collected wireless environment information of the base station 200 to the wired signal transmission unit 215.

The update unit 214 updates the setting of the wireless environment of the base station 200 with control information in the update command on the basis of the received update command. When the update command includes a restart instruction, the update unit 214 restarts the base station 200.

The wired signal transmission unit 215 transmits the received wireless environment information of the base station 200 to the wireless communication management apparatus 100. The wired signal transmission unit 215 transfers the received wireless environment information of the terminal 300 to the wireless communication management apparatus 100.

The wireless signal transmission unit 216 transfers the received collection command and update command of the terminal 300 to the terminal 300.

(Terminal)

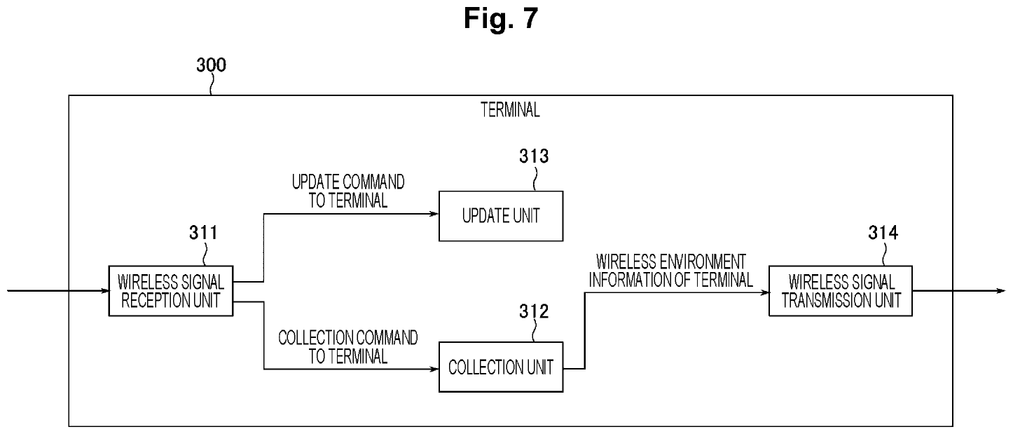

FIG. 7 is a block diagram illustrating an example of a functional configuration of the terminal according to the embodiment.

The CPU of the control circuit 301 controls each of the components 302 and 303 on the basis of various commands transmitted from the wireless communication management apparatus 100. As a result, as illustrated in FIG. 7, the terminal 300 functions as a computer including a wireless signal reception unit 311, a collection unit 312, an update unit 313, and a wireless signal transmission unit 314.

The wireless signal reception unit 311 receives a collection command and an update command from the base station 200. The wireless signal reception unit 311 transmits the collection command to the collection unit 312. The wireless signal reception unit 311 transmits the update command to the update unit 313.

The collection unit 312 collects wireless environment information of the terminal 300 on the basis of the received collection command. The collection unit 312 transmits the collected wireless environment information of the terminal 300 to the wireless signal transmission unit 314.

The update unit 313 updates the setting of the wireless environment of the terminal 300 with control information in the update command on the basis of the received update command. When the update command includes a restart instruction, the update unit 313 restarts the terminal 300.

The wireless signal transmission unit 314 transmits the collected wireless environment information of the terminal 300 to the base station 200.

1.2. Operation

Next, an operation of the communication system according to the embodiment will be described.

1.2.1 State Transition

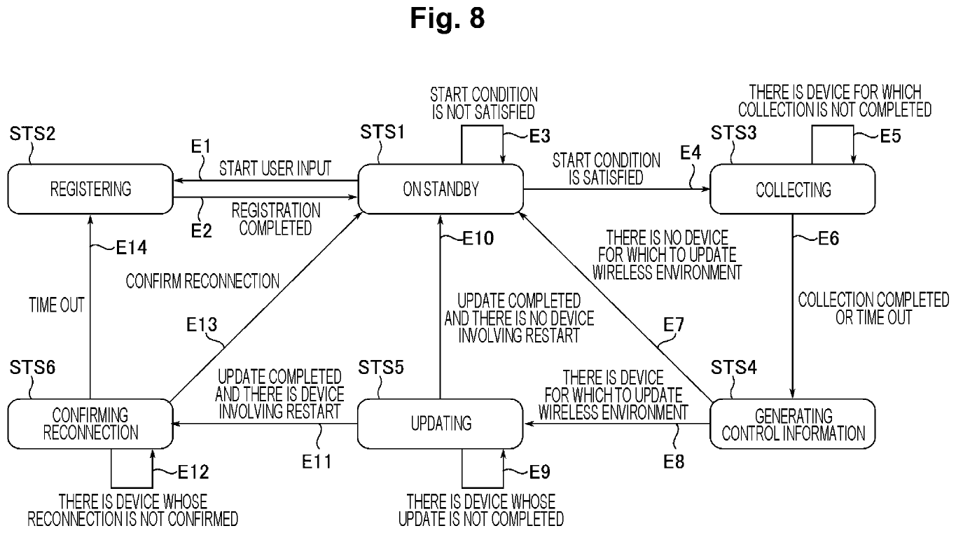

FIG. 8 is a state transition diagram related to the wireless communication management operation in the wireless communication management apparatus according to the embodiment. FIG. 8 illustrates a relationship among a plurality of states that can be taken by the wireless communication management apparatus 100 regarding the wireless communication management operation.

As illustrated in FIG. 8, the wireless communication management apparatus 100 includes, as states related to the wireless communication management operation, a standby state STS1, a registering state STS2, a collecting state STS3, a control information generating state STS4, an updating state STS5, and a reconnection confirming state STS6.

The standby state STS1 is a state in which the wireless communication management apparatus 100 is on standby. The registering state STS2 is a state in which the wireless communication management apparatus 100 is updating registration information. The collecting state STS3 is a state in which the wireless communication management apparatus 100 is collecting wireless environment information from each of the base station 200 and the terminal 300 on the basis of a collection command. In addition, the collecting state STS3 includes a state of collecting external environment information from the external server 400.

The control information generating state STS4 is a state in which the wireless communication management apparatus 100 is generating control information for each of the base station 200 and the terminal 300. The updating state STS5 is a state in which the wireless communication management apparatus 100 is updating the setting of the wireless environment of each of the base station 200 and the terminal 300 on the basis of an update command. The reconnection confirming state STS6 is a state in which the wireless communication management apparatus 100 is confirming whether or not communication with each of the base station 200 and the terminal 300 after a restart is established. A “state in which communication is established” includes, for example, a state in which the wireless communication management apparatus 100 is logged in to each of the base station 200 and the terminal 300 after a restart with SSH.

When user input is started in the standby state STS1 (E1), the wireless communication management apparatus 100 transitions to the registering state STS2. When update of registration information is completed in the registering state STS2, the wireless communication management apparatus 100 transitions to the standby state STS1. When a start condition is not satisfied in the standby state STS1 (E3), the wireless communication management apparatus 100 maintains the standby state STS1. When the start condition is satisfied in the standby state STS1 (E4), the wireless communication management apparatus 100 transitions to the collecting state STS3. The start condition is satisfied by a manual or automatic trigger. In the automatic case, the start condition of a collection operation includes, for example, a predetermined time.

When there is a device for which collection of wireless environment information is not completed in the collecting state STS3 (E5), the wireless communication management apparatus 100 maintains the collecting state STS3. When the collection of wireless environment information is completed or when the timer 105 times out in the collecting state STS3(E6), the wireless communication management apparatus 100 transitions to the control information generating state STS4.

When it is determined in the control information generating state STS4 that there is no device for which to update the setting of the wireless environment (E7), the wireless communication management apparatus 100 transitions to the standby state STS1. When it is determined in the control information generating state STS4 that there is a device for which to update the setting of the wireless environment (E8), the wireless communication management apparatus 100 transitions to an updating state STS5.

When there is a device whose update has not been completed in the updating state STS5 (E9), the wireless communication management apparatus 100 maintains the updating state STS5. When an update operation is completed in the updating state STS5 and there is no device involving a restart (E10), the wireless communication management apparatus 100 transitions to the standby state STS1. When the update operation is completed in the updating state STS5 and there is a device involving a restart (E11), the wireless communication management apparatus 100 transitions to the reconnection confirming state STS6.

When there is a device whose reconnection has not been confirmed in the reconnection confirming state STS6 (E12), the wireless communication management apparatus 100 maintains the reconnection confirming state STS6. When reconnection with a device involving a restart is confirmed in the reconnection confirming state STS6 (E13), the wireless communication management apparatus 100 transitions to the standby state STS1. When the timer 105 times out in the reconnection confirming state STS6 (E14), the wireless communication management apparatus 100 transitions to the registering state STS2.

1.2.2 Wireless Communication Management Operation

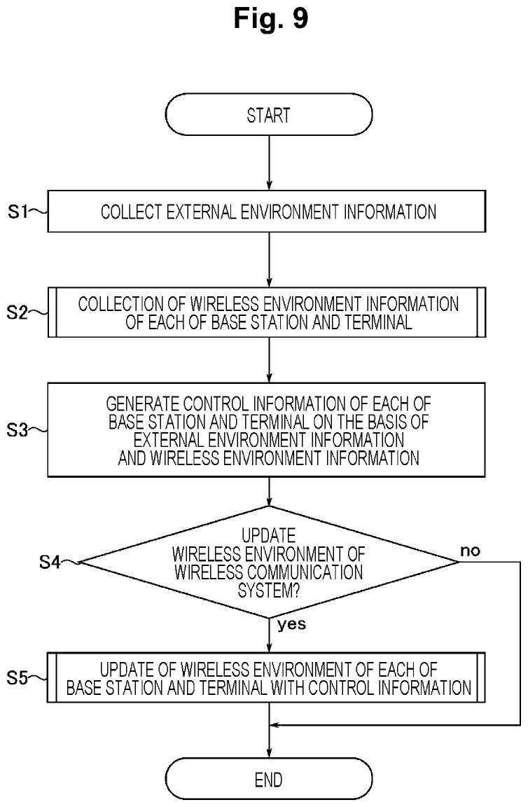

FIG. 9 is a flowchart illustrating an example of the wireless communication management operation in the wireless communication management apparatus according to the embodiment. In FIG. 9, it is assumed that registration information is stored in the memory 102 in advance by user input. In addition, it is assumed that the wireless communication management apparatus 100 has remotely logged in to each device stored in the registration information using a protocol such as SSH.

As illustrated in FIG. 9, when the start condition is satisfied in the standby state STS1 (start), the wireless communication management apparatus 100 collects external environment information from the external server 400 (S1).

The wireless communication management apparatus 100 collects external environment information from each of the base station 200 and the terminal 300 (S2: collection operation). During the processing of S1 and S2, the state of the wireless communication management apparatus 100 changes to the collecting state STS3. The processing of S2 may be performed before the processing of S1, or may be performed in parallel with the processing of S1.

The wireless communication management apparatus 100 generates control information of each of the base station 200 and the terminal 300 on the basis of the collected external environment information and wireless environment information (S3). During the processing of S3, the state of the wireless communication management apparatus 100 changes to the control information generating state STS4.

The wireless communication management apparatus 100 determines whether or not to update the setting of the wireless environment of the wireless communication system 2 (S4).

If it is determined that the setting of the wireless environment of the wireless communication system 2 is to be updated (S4; yes), the wireless communication management apparatus 100 updates the setting of the wireless environment of each of the base station 200 and the terminal 300 with control information (S5: update operation). During the processing of S5, the state of the wireless communication management apparatus 100 changes to the updating state STS5 or the reconnection confirming state STS6. When the processing S5 ends, the wireless communication management operation ends (end).

If it is determined that the setting of the wireless environment of the wireless communication system 2 is not to be updated (S4; no), the wireless communication management operation ends (end). As a result, the state of the wireless communication management apparatus 100 changes to the standby state STS1.

1.2.3 Collection Operation

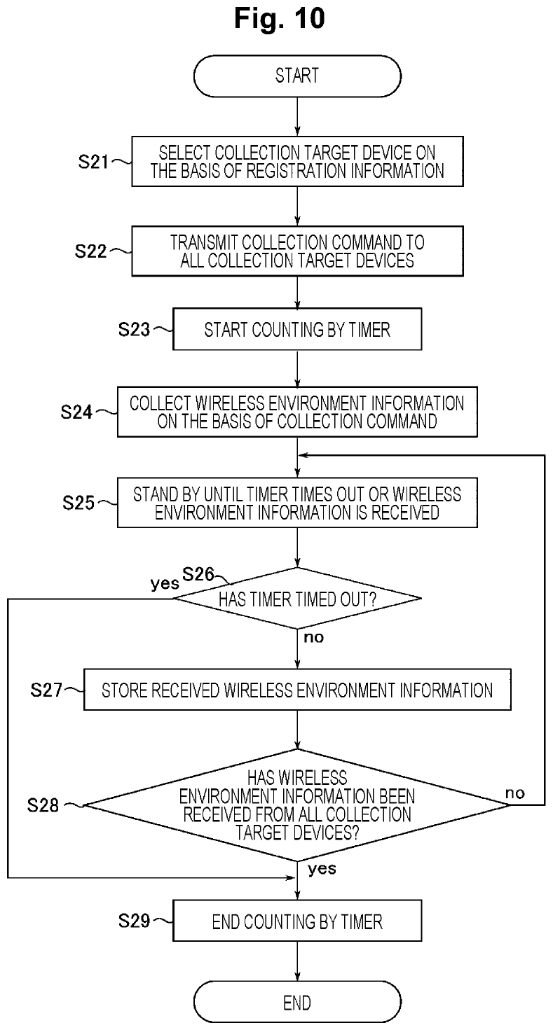

FIG. 10 is a flowchart illustrating an example of the collection operation in the wireless communication management apparatus according to the embodiment. FIG. 10 corresponds to the processing of S2 in FIG. 9.

When the start condition of the collection operation is satisfied (start), the wireless communication management apparatus 100 selects a collection target device on the basis of registration information (S21).

For example, the wireless communication management apparatus 100 selects a device for which the management target flag is set among the base station 200 and the terminal 300 registered in the registration information as a collection target device. Therefore, the collection target device includes at least one terminal 300. In the following example, it is assumed that all the base stations 200-1 and 200-2 and terminals 300-1 to 300-3 in the wireless communication system 2 are selected as collection target devices.

The wireless communication management apparatus 100 transmits a collection command to all the selected collection target devices (S22). Specifically, the wireless communication management apparatus 100 transmits five collection commands addressed to the IP addresses of the base stations 200-1 and 200-2 and the terminals 300-1 to 300-3.

After transmitting the collection commands, the wireless communication management apparatus 100 starts counting by the timer 105 (S23).

When the collection target device receives the collection command designating itself, the collection target device collects wireless environment information on the basis of the collection command (S24). Then, the collection target device transmits the collected wireless environment information to the wireless communication management apparatus 100.

When the counting by the timer 105 is started, the wireless communication management apparatus 100 stands by until the timer 105 times out or wireless environment information is received from any one of the collection target devices (S25).

After the processing of S25, the wireless communication management apparatus 100 determines whether or not the timer 105 has timed out (S26).

If the timer 105 has timed out (S26; yes), the wireless communication management apparatus 100 ends the counting by the timer (S29).

If the timer 105 has not timed out (S26; no), the wireless communication management apparatus 100 stores the received wireless environment information in the memory 102 (S27).

Then, the wireless communication management apparatus 100 determines whether or not wireless environment information has been received from all the collection target devices (S28).

If there is a collection target device whose wireless environment information has not been received (S28; no), the processing proceeds to S25. As a result, the processing of S25 to S28 is repeated until wireless environment information is received from all the collection target devices or the timer 105 times out.

If wireless environment information has been received from all the collection target devices (S28; yes), the wireless communication management apparatus 100 ends the counting by the timer (S29).

When the processing of S29 ends, the collection operation ends (end).

1.2.4 Update Operation

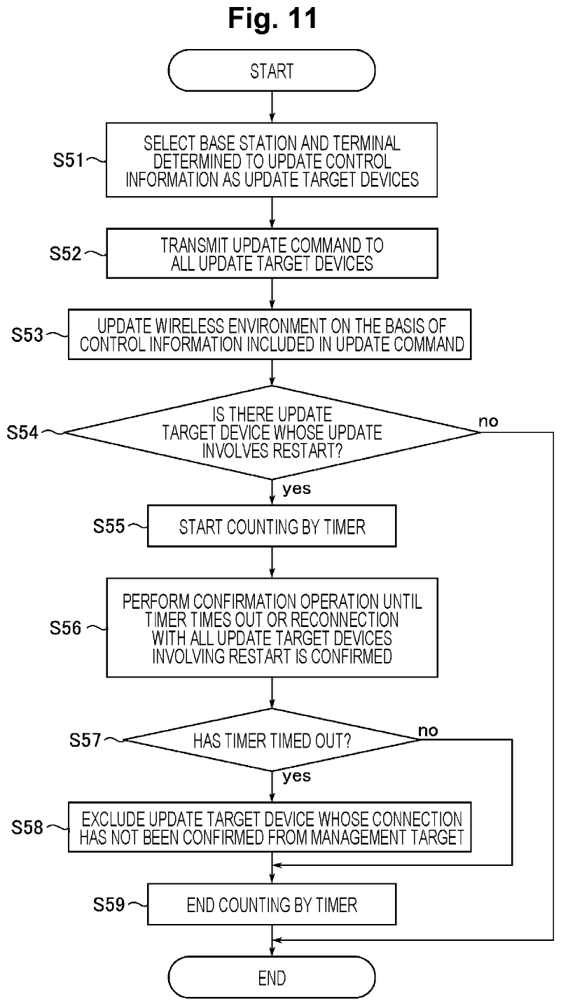

FIG. 11 is a flowchart illustrating an example of the update operation in the wireless communication management apparatus according to the embodiment. FIG. 11 corresponds to the processing of S5 in FIG. 9.

If it is determined that the setting of the wireless environment of the wireless communication system 2 is to be updated (start), the wireless communication management apparatus 100 selects the base station 200 and the terminal 300 determined to update control information as update target devices (S51).

For example, in a case where generated control information is different from the currently set control information, the wireless communication management apparatus 100 selects the base station 200 or the terminal 300 corresponding to the control information as an update target device. When generated control information matches the currently set control information, the wireless communication management apparatus 100 excludes the base station 200 or the terminal 300 corresponding to the control information from the update target device. In the following example, it is assumed that all the base stations 200-1 and 200-2 and terminals 300-1 to 300-3 in the wireless communication system 2 are selected as update target devices.

The wireless communication management apparatus 100 transmits an update command to all the selected update target devices (S52). Specifically, the wireless communication management apparatus 100 transmits five update commands addressed to the IP addresses of the base stations 200-1 and 200-2 and the terminals 300-1 to 300-3.

When the update command designating itself is received after the processing of S52, the update target device updates the setting of the wireless environment on the basis of the control information in the update command (S53). Then, the update target device transmits information indicating that the update is completed to the wireless communication management apparatus 100. Note that when the received update command instructs a restart, the update target device continues to execute a restart after the update of the control information.

The wireless communication management apparatus 100 determines whether or not there is a device involving a restart after the update of the wireless environment among the selected update target devices (S54).

If there is no update target device involving a restart after the update of the wireless environment (S54; no), the update operation ends (end).

If there is an update target device involving a restart after the update of the wireless environment (S54; yes), the wireless communication management apparatus 100 starts counting by the timer 105 (S55).

When the counting by the timer 105 is started, the wireless communication management apparatus 100 performs a reconnection confirmation operation until the timer 105 times out or reconnection with all the update target devices involving a restart is confirmed (S56).

After the processing of S56, the wireless communication management apparatus 100 determines whether or not the timer 105 has timed out (S57).

If the timer 105 has not timed out (S57; no), the wireless communication management apparatus 100 ends the counting by the timer (S59).

If the timer 105 has timed out (S57; yes), the wireless communication management apparatus 100 excludes the update target device whose connection has not been confirmed from the management target (S58). For example, the wireless communication management apparatus 100 refers to registration information and eliminates the management target flag of the update target device whose connection has not been confirmed. As a result, in the wireless communication management operation, the device whose management target flag is eliminated is temporarily excluded from the management target.

Note that the wireless communication management apparatus 100 may continuously perform the reconnection confirmation operation for the update target device whose connection has not been confirmed until the subsequent wireless communication management operation starts after the end of the current wireless communication management operation. Then, when the connection can be confirmed, the wireless communication management apparatus 100 sets the management target flag corresponding to the update target device of which the connection can be confirmed. As a result, the update target device can be included in the management target in the next and subsequent wireless communication management operations.

After the update of the registration information is completed, the wireless communication management apparatus 100 ends the counting by the timer (S59).

When the processing of S59 ends, the update operation ends (end).

1.3 Effects According to Embodiment

According to the embodiment, the wireless communication management apparatus 100 collects wireless environment information from the terminal 300 by using a collection command. The wireless communication management apparatus 100 generates control information of the terminal 300 on the basis of the collected wireless environment information of the terminal 300. The wireless communication management apparatus 100 updates the setting of the wireless environment of the terminal 300 using the update command on the basis of the generated control information of the terminal 300. As a result, the wireless environment of the terminal 300 can be optimized. Therefore, even in a use case where the uplink traffic from the terminal 300 is the main communication, deterioration of throughput can be curbed.

In addition, in a case where the update operation of the terminal 300 involves a restart, the wireless communication management apparatus 100 restarts the terminal 300 whose setting has been updated. The wireless communication management apparatus 100 reconnects communication with the restarted terminal 300 by SSH. As a result, the wireless communication management apparatus 100 can maintain a state of remotely operating the terminal 300 in the wireless communication system 2. Therefore, the wireless communication management apparatus 100 can maintain a state of performing the wireless communication management operation even after the restart of the terminal 300.

In addition, in a wireless LAN for public use, an unspecified number of terminals can freely start connection with the wireless communication system and freely terminate the connection with the wireless communication system. Therefore, when managing wireless communication of a public wireless LAN, it is difficult for the wireless communication management apparatus to manage which terminal is connected. That is, when managing wireless communication of a public wireless LAN, it is difficult for the wireless communication management apparatus to consider the individual wireless environment of a terminal.

On the other hand, in the wireless communication system 2 according to the embodiment, the wireless communication management apparatus 100 specifies the terminal 300 to be managed in advance by registration information. Therefore, the wireless communication management apparatus 100 can manage which terminal is connected.

In addition, wireless environment information of the terminal 300 includes the remaining capacity of the battery. As a result, when the terminal 300 supplies power by solar power generation, the wireless communication management apparatus 100 can generate, as control information, a transmission frequency that can be operated without causing battery exhaustion. Therefore, transmission management of the terminal 300 can be concentrated in the wireless communication management apparatus 100. Accordingly, the operation load of the wireless communication system 2 can be reduced.

In addition, wireless environment information of the terminal 300 includes a channel, a bandwidth, a frequency, and an RSSI of the peripheral BSS. As a result, the wireless communication management apparatus 100 can generate, as control information, the access parameter, the channel, the transmission rate, and the like of the terminal 300. Therefore, it is possible to curb collision of communication between the terminals 300 and to optimize a modulation/demodulation scheme. Therefore, it is possible to perform an operation in consideration of an interference state between the terminal 300 and peripheral devices. Therefore, data transmission in the wireless communication system 2 can be stabilized.

2. Modification

Note that various modifications can be applied to the above-described embodiment.

For example, while the above embodiment describes a case where the terminal 300 and the base station 200 perform wireless communication directly, the present invention is not limited thereto. For example, the terminal 300 and the base station 200 may be configured to wirelessly communicate with each other via a base station (relay base station) that relays wireless communication.

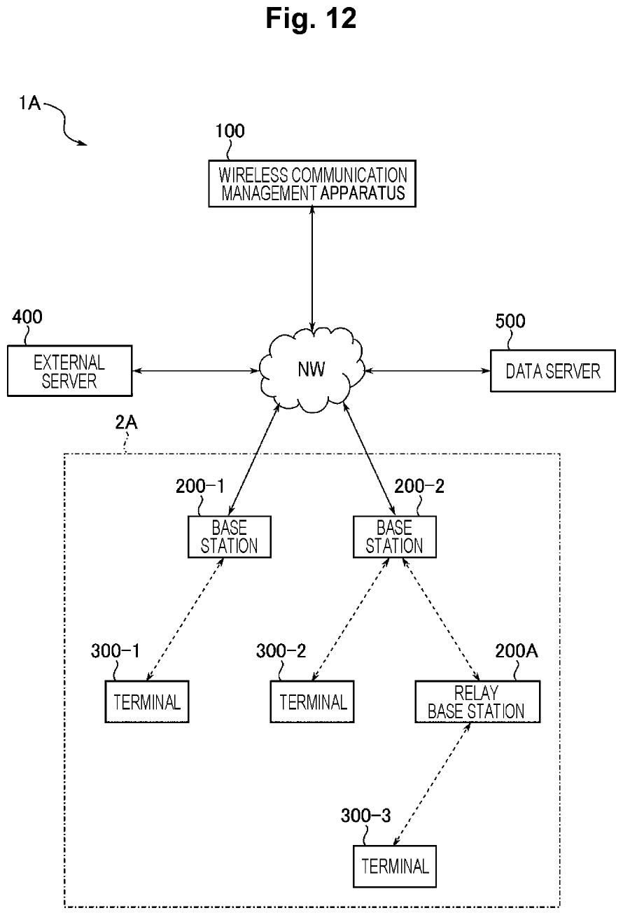

FIG. 12 is a block diagram illustrating an example of a configuration of a communication system according to a modification of the embodiment.

As illustrated in FIG. 12, a communication system 1A includes a wireless communication system 2A.

The wireless communication system 2A includes a plurality of base stations 200-1 and 200-2, a relay base station 200A, and a plurality of terminals 300-1 to 300-3.

The relay base station 200A is configured to wirelessly connect the base station 200 and the terminal 300. The example of FIG. 12 illustrates a case where the relay base station 200A wirelessly connects the base station 200-2 and the terminal 300-3. By forming the wireless communication network via the relay base station 200A in this manner, it is possible to construct the wireless communication system 2A in which the terminals 300 are distributed over a wider range.

The relay base station 200A has, for example, a hardware configuration similar to the hardware configuration of the base station 200 illustrated in FIG. 3. Therefore, the relay base station 200A can also function as the base station 200. Note that in the example of the wireless communication system 2A illustrated in FIG. 12, the relay base station 200A has a function of wirelessly connecting the base station 200 and the terminal 300, and thus does not use the wired communication module 203.

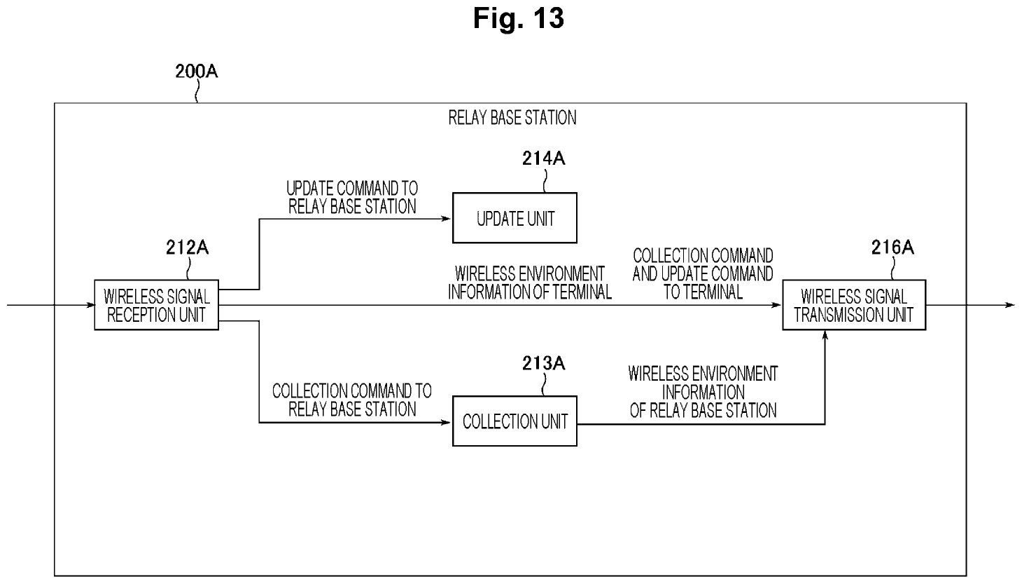

FIG. 13 is a block diagram illustrating an example of a functional configuration of the relay base station according to the modification of the embodiment.

As illustrated in FIG. 13, the relay base station 200A functions as a computer including a wireless signal reception unit 212A, a collection unit 213A, an update unit 214A, and a wireless signal transmission unit 216A.

The wireless signal reception unit 212A receives a collection command and an update command from the base station 200. When receiving a collection command (to relay base station 200A) addressed to the relay base station 200A, the wireless signal reception unit 212A transfers the collection command to the collection unit 213A. When receiving an update command to the relay base station 200A, the wireless signal reception unit 212A transfers the update command to the update unit 214A. When receiving a collection command and an update command (to terminal 300) addressed to the terminal 300, the wireless signal reception unit 212A transmits the collection command and the update command to the wireless signal transmission unit 216A.

In addition, the wireless signal reception unit 212A receives wireless environment information of the terminal 300 from the terminal 300. The wireless signal reception unit 212A transmits the received wireless environment information of the terminal 300 to the wireless signal transmission unit 216A.

The collection unit 213A collects wireless environment information of the relay base station 200A on the basis of the received collection command. The collection unit 213A transmits the collected wireless environment information of the relay base station 200A to the wireless signal transmission unit 216A.

The update unit 214A updates the setting of the wireless environment of the relay base station 200A with control information in the update command on the basis of the received update command. When the update command includes a restart instruction, the update unit 214A restarts the relay base station 200A.

The wireless signal transmission unit 216A transmits the received wireless environment information of the relay base station 200A to the wireless communication management apparatus 100. The wireless signal transmission unit 216A transfers the received wireless environment information of the terminal 300 to the wireless communication management apparatus 100. The wireless signal transmission unit 216A transfers the received collection command and update command of the terminal 300 to the terminal 300.

With the above configuration, the wireless communication management apparatus 100 can collect the wireless environment information of the terminal 300 via the base station 200 and the relay base station 200A. In addition, the wireless communication management apparatus 100 can collect the wireless environment information of the relay base station 200A via the base station 200.

In addition, the wireless communication management apparatus 100 can further consider the wireless environment information of the relay base station 200A. Specifically, for example, the wireless communication management apparatus 100 can compare a propagation path via the relay base station 200A with a propagation path not via the relay base station 200A. As a result, the wireless communication management apparatus 100 can generate an optimum propagation path in the wireless communication system 2A as the control information. Therefore, the wireless environment in the wide-area wireless communication system 2A can be optimized.

3. Others

Furthermore, for example, while the above embodiment describes a case where the wireless communication management program is executed by the on-premises wireless communication management apparatus 100, the present invention is not limited thereto. For example, the wireless communication management program may be executed on a calculation resource on the cloud.

Furthermore, for example, while the above embodiment describes a case where the wireless communication management apparatus 100 is connected to the base station 200 via the network NW, the present invention is not limited thereto. For example, the wireless communication management apparatus 100 may be provided in the wireless communication system 2 and function as the root base station 200. In this case, the wireless communication management apparatus 100 may be configured to have both the functional configuration illustrated in FIG. 5 and the functional configuration illustrated in FIG. 6.

Furthermore, while the above embodiment describes a case where the wireless communication management apparatus 100 and the data server 500 are physically different servers, the present invention is not limited thereto. That is, the wireless communication management apparatus 100 and the data server 500 may be physically configured in the same server.

Furthermore, the above embodiment describes a case where SSH is used for communication among the wireless communication management apparatus 100, the base station 200, and the terminal 300. However, communication among the wireless communication management apparatus 100, the base station 200, and the terminal 300 is not limited to SSH and any protocol can be used as long as the wireless communication management apparatus 100 can remotely log in to the base station 200 and the terminal 300 and transmit various commands.

Note that the present invention is not limited to the foregoing embodiments and various modifications can be made in the implementation stage without departing from the gist of the invention. In addition, each embodiment may be implemented in appropriate combination, and in that case, combined effects can be obtained. Furthermore, the embodiments described above include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

1, 1A Communication system
2, 2A Wireless communication system
100 Wireless communication management apparatus
200-1, 200-2 Base station
200A Relay base station
300-1, 300-2, 300-3 Terminal
400 External server
500 Data server
101, 201, 301 Control circuit
102, 202, 302 Memory
103, 203 Wired communication module
104 User interface
105 Timer
106 Drive
107 Storage medium
204, 303 Wireless communication module
304 Sensor
305 Battery
111 User input unit
112, 211 Wired signal reception unit
113 Control information generation unit
114 Determination unit
115, 215 Wired signal transmission unit
116 Command library
212, 212A, 311 Wireless signal reception unit
213, 213A, 312 Collection unit
214, 214A, 313 Update unit
216, 216A, 314 Wireless signal transmission unit

1. A wireless communication management apparatus comprising:
a reception unit configured to receive first wireless environment information from a terminal configured to wirelessly communicate with a base station;
a generation unit configured to generate first control information of the terminal on the basis of the first wireless environment information; and
a transmission unit configured to transmit the first control information to update a setting of the terminal.

2. The wireless communication management apparatus according to claim 1, wherein the wireless communication management apparatus is configured to specify the terminal as a management target before receiving the first wireless environment information.

3. The wireless communication management apparatus according to claim 1, wherein the wireless communication management apparatus is configured to:
generate a command to restart the updated terminal; and
connect communication with the restarted terminal.

4. The wireless communication management apparatus according to claim 3, wherein the connecting includes connecting by a secure shell (SSH).

5. The wireless communication management apparatus according to claim 1, wherein
the reception unit is configured to receive second wireless environment information from a relay base station configured to wirelessly communicate between the base station and the terminal,
the generation unit is configured to generate each of the first control information and second control information of the relay base station on the basis of the first wireless environment information and the second wireless environment information, and
the transmission unit is configured to transmit the second control information to update a setting of the relay base station.

6. The wireless communication management apparatus according to claim 1, wherein the first wireless environment information includes a remaining capacity of a battery of the terminal.

7. The wireless communication management apparatus according to claim 1, wherein the first wireless environment information includes a received signal strength indication (RSSI) observed by the terminal.

8. A wireless communication management method comprising:
receiving first wireless environment information from a terminal configured to wirelessly communicate with a base station;
generating first control information of the terminal on the basis of the first wireless environment information; and
transmitting the first control information to update a setting of the terminal.

9. A non-transitory computer-readable storage medium storing a wireless communication management program used in a wireless communication management apparatus, the program causing a computer to:
receiving first wireless environment information from a terminal configured to wirelessly communicate with an access point;
generating first control information of the terminal on the basis of the first wireless environment information; and
transmitting the first control information to update a setting of the terminal.
